(19) United States
(12) Patent Application Publication
(10) Pub. No.: US 2009/0220697 A1
(43) Pub. Date: Sep. 3, 2009

(54) Washcoat composition and methods of making and using

(76) Inventor: William Peter Addiego, Big Flats, NY (US)

Correspondence Address: CORNING INCORPORATED, SP-TI-3-1, CORNING, NY, 14831, US

(21) Appl. No.: 12/074,100

(22) Filed: Feb. 29, 2008

(51) Int. Cl. B05D 3/02

(52) U.S. Cl. 427/372.2; 106/287.18

(57) ABSTRACT

Washcoat compositions and methods for the preparation and use thereof. A washcoat composition comprising a soluble washcoat salt species, a polar organic solvent, and an insoluble particulate material is disclosed. Also disclosed is a substrate at least partially coated with the inventive washcoat composition. A method for making a washcoat composition comprising contacting a soluble washcoat salt species, a polar organic solvent, and an insoluble particulate material is disclosed. Also disclosed is a method for coating a substrate with a washcoat, the method comprising contacting at least a portion of a substrate with the inventive washcoat composition.

### BACKGROUND OF THE INVENTION

1. Field of the Invention

The present invention relates to washcoat compositions and methods for the manufacture and use thereof.

2. Technical Background

Supported catalyst materials are typically utilized in applications where a highly dispersed catalyst is needed, such as, for example, hydrodesulfurization, hydrogenation, methanation, methanol synthesis, ammonia synthesis, and various petrochemical processes. In such applications, a washcoat can be utilized to provide a suitable surface on a substrate for stabilizing the highly dispersed catalyst.

Conventional methods for manufacturing such supported catalysts have comprised co-precipitating a catalyst metal with the support, resulting in a hydrogel of an oxide, such as, for example, alumina, ceria, or titania. Such conventional methods have not provided materials that can allow a high throughput of reactants across or through a catalyst layer. After calcination, the resulting fine powder and dispersed catalyst particles produced by such conventional methods cannot be easily applied to many substrate materials.

The materials produced by conventional methods also fail to provide a catalyst layer having good adhesion and cohesion properties. There is a need to address the aforementioned problems and other shortcomings associated with traditional catalyst materials and methods. These needs and other needs are satisfied by the catalyst washcoat technology of the present invention.

### SUMMARY OF THE INVENTION

The present invention relates to washcoat compositions and methods for the manufacture and use thereof. The present invention addresses at least a portion of the problems described above through the use of a novel washcoat, and methods of making and applying the inventive washcoat to a substrate.

In one aspect, the present invention provides a washcoat composition comprising a soluble washcoat salt species, a polar organic solvent, and an insoluble particulate material.

In another aspect, the present invention provides a substrate at least partially coated with the washcoat composition described above.

In yet another aspect, the present invention provides a method for making a washcoat composition, the method comprising contacting a soluble washcoat salt species, a polar organic solvent, and an insoluble particulate material.

In yet another aspect, the present invention provides a method for coating a substrate with a washcoat composition, the method comprising contacting at least a portion of a substrate with the washcoat composition described above.

Additional aspects and advantages of the invention will be set forth, in part, in the detailed description and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### DETAILED DESCRIPTION OF THE INVENTION

The present invention can be understood more readily by reference to the following detailed description, examples, and claims, and their previous and following description. However, before the present compositions, articles, and methods are disclosed and described, it is to be understood that this invention is not limited to the specific compositions, articles, and methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its currently known aspects. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “compound” includes aspects having two or more such compounds, unless the context clearly indicates otherwise.

“Optional” or “optionally” means that the subsequently described event or circumstance can or cannot occur, and that the description includes instances where the event or circumstance occurs and instances where it does not. For example, the phrase “optional component” means that the component can or can not be present in the composition and that the invention includes both aspects wherein the component is present and wherein the component is not present.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

As used herein, the term “washcoat” is intended to refer to a composition that, when applied to a substrate, can provide a high surface area porous surface suitable for stabilizing one or more catalyst particles. A washcoat can optionally include one or more catalyst particles that are to be applied to a substrate.

As used herein, the terms “substrate,” “support,” “core,” and “monolith” are intended to refer to a body onto which a washcoat and optionally one or more catalyst particles can be deposited. A substrate, support, core, and/or monolith can have any form and/or geometry, such as, for example, honeycomb, stacked, coiled, woven, foamed, or a combination thereof, and can be comprised of any suitable for the intended application.

As used herein, the terms “nano” and “nano-particle” are intended to refer to particles having, in various aspects, at least one aspect with an average particle size of less than about 100 nm, less than about 10 nm, or less than about 5 nm.

As briefly introduced above, the present invention provides an improved washcoat composition and methods for making and using the inventive washcoat composition. The inventive washcoat composition can provide improved adhesion to a substrate material and/or improved cohesion between washcoat and/or catalyst particles over conventional washcoat materials. In one aspect, the washcoat composition of the present invention comprises a soluble washcoat salt species, a polar organic solvent, and an insoluble particulate material.

The washcoat composition of the present invention can be utilized to at least partially coat any substrate suitable for a desired application. In one aspect, the substrate is a monolith, such as, for example, a honeycomb structure. A substrate, such as a monolith, can be comprised of any material suitable for being coated with the inventive washcoat composition and for use in a desired application. In one aspect, a substrate is comprised of an inorganic refractory material. In other aspects, a substrate is comprised of a glass, a ceramic, a glass-ceramic, or a combination thereof. In various specific aspects, a substrate is comprised of cordierite, aluminum titanate, titania, alumina, such as, for example, α-alumina, γ-alumina, or other ceramic material and/or combinations thereof. In other aspects, a substrate is comprised of a carbon material, such as, for example, a glassy carbon. In yet other aspects, a substrate is comprised of a metal, such as, for example, aluminum. In still other aspects, a substrate is comprised of a polymeric material, such as, for example, a thermoplastic. It should be noted that the present invention is not limited to the specific substrate materials recited herein and can thus comprise any suitable material, including, for example, a combination of any two or more recited materials. The particular form of a substrate material can also vary depending upon the intended application, washcoat, and substrate composition. In various aspects, the substrate can comprise a solid material, a sponge, such as, for example, a metal or plastic sponge, a sintered material, or a combination thereof. As such, a substrate can comprise, in various aspects, a porous material, a non-porous material, a semi-porous material, or a combination thereof.

In various aspects, the soluble washcoat salt species of the present invention can comprise any salt species that is at least partially soluble in one or more polar organic solvents, water, or a combination thereof. In one aspect, the soluble washcoat salt species is at least partially soluble in water. In one aspect, the soluble washcoat salt species is at least partially soluble in a polar organic solvent.

In another aspect, the soluble washcoat salt species is substantially soluble in a polar organic solvent. In various aspects, the soluble washcoat salt species has a solubility greater than about 1 ppm, such as, for example, about 1.5, 2, 5, 10, 50, 100, 200, 400, 500, 800, 1,000, 1,500, 2,000, 3,000, or 10,000 ppm; or greater than about 1,000 ppm, for example, about 1,000, 1,500, 2,000, 3,000, 5,000, 10,000, 15,000, 20,000, 30,000, 50,000 ppm or more in water, a polar organic solvent, or a combination thereof. It should be understood that the solubility of any particular soluble washcoat salt species can vary depending upon such factors as pH, temperature, the particular counterion of a salt species present, and/or the nature and polarity of the solvent employed, and the present invention is not intended to be limited to any particular level of solubility. It should be noted that the solvent of the present invention can comprise a polar organic solvent, water, or a combination thereof, and that the soluble washcoat salt species should be at least partially soluble in the particular solvent and/or combination of solvents employed.

In other aspects, the soluble washcoat salt species can form a colloidal solution and/or a sol in the particular solvent and/or combination of solvents employed, provided that at least a portion of the soluble washcoat salt species is at least partially ionized.

In one aspect, the soluble washcoat salt species comprises at least one soluble cationic species and at least one soluble anionic species. In various aspects, the soluble cationic species comprises a transition metal, an alkali metal, an alkali earth metal, a rare earth metal, or a combination thereof. In various aspects, the soluble anionic species comprises a nitrate, a halide, a sulfate, a sulfite, a nitrite, a phosphate, a carbonate, an oxalate, a carboxylate (e.g., a formate or an acetate), or a combination thereof. In other aspects, the soluble anionic species comprises a polyoxometalate (e.g., [PMo₁₂O₄₀]³⁻) wherein a transition metal species is anionic and a counter ion (e.g., [NH₄]¹⁺) is cationic. In such as aspect comprising a polyoxometalate, such as, for example, [PMo₁₂O₄₀]³⁻, a metal oxide, such as, for example, molybdenum oxide, can act as a binder.

In various aspects, the soluble washcoat salt species comprises an iron compound, a zinc compound, an aluminum compound, or a combination thereof. In a preferred aspect, the soluble washcoat salt species comprises an iron compound, such as, for example, iron nitrate, iron sulfate, iron chloride, or a combination thereof. In other aspects, the soluble washcoat salt species can comprise a hydroxide, such as, for example, iron hydroxide, an oxyhydride, or a combination thereof. While not wishing to be bound by theory, it is believed that iron can promote catalysis when used with certain metal catalyst particles, and the presence of iron can help maintain small, high surface area, metal catalyst particles.

The concentration of the soluble washcoat salt species can vary, depending upon the specific salt species, polar organic solvent, and conditions such as, for example, temperature and/or pH. In various aspects, the concentration of the soluble washcoat salt species can range from about 0.01 M to the maximum solubility limit of the salt; or from greater than about 0.01 M to about 10 M, for example, about 0.01, 0.02, 0.05, 0.08, 0.1, 0.2, 0.25, 0.3, 0.4, 0.5, 0.6, 0.7, 0.8, 0.9, 1.0, 1.1, 1.2, 1.3, 1.4, 1.5, 1.6, 1.8, 2, 2.5, 3, 3.5, 4, 5, 6, 7, 8, 9 or 10 M. In other aspects, the concentration of the soluble washcoat salt species can be less than about 0.01 M or greater than about 10.0 M, and the present invention is not intended to be limited to any particular concentration range. In one specific aspect, the soluble washcoat salt species comprises an iron nitrate and is present at a concentration of about 1.6 M. In other aspects, the soluble washcoat salt species can comprise multiple salt species having the same or different cations.

The insoluble particulate material of the present invention can comprise any material suitable for use in the intended application. In one aspect, the insoluble particulate material can comprise a substantial portion of and/or the largest volume fraction of a washcoat composition. In various aspects, the insoluble particulate material can act as a binder. In one aspect, the insoluble particulate material comprises an oxide, such as, for example iron oxide, zinc oxide, tin oxide, ceria, titania, alumina, silica, spinel, perovskite, or a combination thereof. In yet other aspects, the insoluble particulate material can comprise a carbide, a nitride, a particulate carbonaceous material (e.g., activated carbon and/or carbon black), or a combination thereof. The insoluble particulate material can comprise a plurality of individual insoluble particulate materials having the same or different composition. In one aspect, the insoluble particulate material comprises an oxide, wherein the oxide comprises the same cation (e.g., metal) as the soluble washcoat salt species, or of at least one salt species of the soluble washcoat salt species if multiple salt species are present. In a specific aspect, the insoluble particulate material comprises an iron oxide.

The particular composition and/or phase of an insoluble particulate material can vary. In various aspects, the insoluble particulate material comprises alpha, gamma, delta, eta, theta, kappa, rho, and/or chi alumina, silica, silica aluminate, zeolite, silica-magnesia, titanium oxide, zirconium oxide, or a combination thereof.

In one aspect, the insoluble particulate material does not exhibit any catalytic activity. In another aspect, the insoluble particulate material can exhibit catalytic activity without the addition of another catalyst. In a specific aspect, the insoluble particulate material comprises an iron compound, such as, for example, iron oxide, that can exhibit catalytic activity. In another aspect, the insoluble particulate material is capable of being combined with a catalyst, without regard for whether the insoluble particulate material alone exhibits catalytic activity. Example catalysts include, for example, metal oxide catalysts, transition metals, metallocenes, heteropoly catalysts, and chelated metal catalysts, including those ordinarily used in homogeneous catalysis.

In yet another aspect, the insoluble particulate material comprises a material onto which a catalyst material can be contacted, deposited, and/or adsorbed. In yet another aspect, the insoluble particulate material can exhibit catalytic activity and can further be combined with a catalyst such as one mentioned above. In yet another aspect, an insoluble particulate material and a catalyst can be co-precipitated by, for example, dissolving a particulate material and a catalyst material in a solvent, and then adjusting the pH of the resulting solution so as to precipitate the insoluble particulate material having a plurality of catalyst particles dispersed thereon.

The insoluble particulate material of the present invention can be present at a concentration of from about 10 wt. % to about 95 wt. %, for example, about 10, 15, 20, 25, 30, 35, 40, 45, 50, 55, 60, 65, 70, 75, 80, 85, 90, or 95 wt. %; from about 20 wt. % to about 90 wt. %, for example, about 20, 25, 30, 35, 40, 45, 50, 55, 60, 65, 70, 75, 80, 85, or 90 wt. %; or from about 50 wt. % to about 90 wt. %, for example, about 50, 55, 60, 65, 70, 75, 80, 85, or 90 wt. %. In other aspects, the insoluble particulate material can be present at concentrations of less than about 10 wt. % or greater than about 95 wt. % and the present invention is not intended to be limited to any particular concentration range recited herein.

In one aspect, when combined with an insoluble particulate material, the concentration of the soluble washcoat salt species, expressed as its equivalent oxide, can comprise less than about 80 wt. %, for example, about 79, 78, 75, 72, 70, 65, 60, 55, 50, 45, 40, 35, 30, 25, 20, 18, 16, 14, 12, 10, 8, 6, 4, or 2 wt. % of the total dry composition; or less than about 20 wt. %, for example, about 18, 16, 14, 12, 10, 8, 6, 4, or 2 wt. % of the total dry composition.

The polar organic solvent can be any organic solvent suitable for use in a desired application. In one aspect, the polar organic solvent has a polarity sufficient to dissolve at least a portion of the soluble washcoat salt species. In another aspect, the polar organic solvent has a polarity sufficient to substantially dissolve the soluble washcoat salt species. In yet another aspect, the polar organic solvent has a polarity sufficient to completely dissolve the soluble washcoat salt species. While not wishing to be bound by theory, it is believed that the polar organic solvent can promote the binding quality of the soluble washcoat salt species to the insoluble particulate material.

As used herein, the term “polar” is intended to refer to a molecule and/or functional group that has a permanent dipole, can be easily acceptable to electrophoresis under an electric field, can be highly miscible with water, and/or a combination thereof.

In one aspect, the polar organic solvent comprises at least one polar functional group, such as, for example, an oxygen containing functional group and/or a nitrogen containing functional group. In various specific aspects, the polar organic solvent comprises at least one of an ether, a hydroxyl, a carboxylic, an amide, an amine, or a combination thereof.

In various aspects, the polar organic solvent comprises ethylene glycol monoethyl ether, ethylene glycol monomethyl ether, glyoxal, dialdehyde, or a combination and/or derivative thereof. It should be appreciated that some polar organic solvents can exhibit instability and/or can form organic peroxides in certain environments, for example, upon exposure to air. The present invention is intended to cover any polar organic solvent that can be safely employed using existing methods and/or methods developed in the future. In one aspect, the polar organic solvent comprises one or more materials that are chemically and physically stable, and/or that have a shelf life of at least about six weeks without additional purification and/or distillation steps.

In various aspects, the polar organic solvent has a boiling point of less than about 200° C., for example, about 180, 160, 140, 130, 120, 110, 100, 90, 80, 70, or 60° C.; or less than about 130° C., for example, about 130, 120, 110, 100, 90, 80, 70, or 60° C. In other aspects, the polar organic solvent can have a boiling point of greater than about 200° C. or less than about 60° C. In other aspects, the polar organic solvent has a density of less than about 2 g/ml, for example, about 1.9, 1.8, 1.7, 1.6, 1.5, 1.4, 1.3, 1.2, 1.1, or 1 g/ml; from about 1.1 g/ml to about 1.4 g/ml, for example, about 1.1, 1.2, 1.3, or 1.4 g/ml; or from about 1.2 g/ml to about 1.3 g/ml, for example, about 1.2, 1.22, 1.24, 1.26, 1.28, or 1.3 g/ml.

In one aspect, the polar organic solvent can prevent, reduce, and/or slow the recrystallization of the soluble washcoat salt species.

The amount of polar organic solvent utilized can vary depending upon the concentration ranges of the soluble washcoat salt species and the insoluble particulate material, the polarity of the polar organic solvent, and the desired viscosity of the resulting mixture.

One advantage of the washcoat composition and methods of the present invention is that with careful selection of polar organic solvent, the solvent can act to at least partially dissolve a salt that can act as a washcoat binder upon drying and calcinations, wherein the organic residue can help reduce recrystallization of the soluble washcoat salt species upon drying, and can act as a dispersant aid for the, resulting in a strong, uniform washcoat layer.

The soluble washcoat salt species, polar organic solvent, and insoluble particulate material can be contacted to provide a slurry. In one aspect, the resulting slurry can optionally be mixed to provide a uniform or substantially uniform mixture of the soluble washcoat salt species, polar organic solvent, and insoluble particulate material. In another aspect, the resulting slurry is milled, for example, ball-milled with milling media for a period of time sufficient to at least partially homogenize and de-agglomerate the particles in the slurry. In other aspects, the resulting slurry is milled for at least about one hour, or at least about three hours.

While not wishing to be bound by theory, it is believed that factors such as the surface area, porosity, and median particle size and particle size distribution of the insoluble particulate material in a slurry can affect the quality of a coating. The particle size and distribution of an insoluble particulate material in a slurry composition can be modified by one or more milling steps. In one aspect, the insoluble particulate material in a slurry has a median particle size of less than about 50 μm, for example, about 48, 46, 44, 42, 40, 35, 30, 25, 20, 15, 10, 9, 8, 7, 6, 5, 4, 3, 2, 1, 0.8, 0.6, 0.4, 0.2, 0.1, 0.08, 0.06, 0.04, 0.02, or 0.01 μm; or less than about 10 μm, for example, about 9, 8, 7, 6, 5, 4, 3, 2, 1, 0.8, 0.6, 0.4, 0.2, 0.1, 0.08, 0.06, 0.04, 0.02, or 0.01 μm.

A slurry can optionally further comprise a solid inorganic binder. A solid inorganic binder, if present, can have a median particle size less than that of the insoluble particulate material. In various aspects, a solid inorganic binder, if present, has a median particle size of less than about 5 μm, for example, about 4.5, 4, 3.5, 3, 2.5, 2, 1.5, 1, 0.9, 0.8, 0.7, 0.6, 0.5, 0.4, 0.3, 0.2 μm or less; or less than about 1 μm, for example, about 0.9, 0.8, 0.7, 0.6, 0.5, 0.4, 0.3, 0.2 μm or less. A solid inorganic binder, if present, can comprise the same or different composition as the insoluble particulate material. In one aspect, a slurry does not comprise a solid inorganic binder. In another aspect, a slurry comprises a solid inorganic binder having the same composition as the insoluble particulate material. In such an aspect, the solid inorganic binder can comprise a separate material added to the slurry and/or can comprise a particle size fraction of the insoluble particulate material. In yet another aspect, a slurry comprises a solid inorganic binder having a different composition as the insoluble particulate material. In yet another aspect, a solid inorganic binder, if present, can comprise more than one individual solid inorganic binder component, wherein each of the more than one individual solid inorganic binder components can comprise either the same or different components.

The solubility of any one or more soluble washcoat salt species or insoluble particulate materials in the slurry can be adjusted by modifying the pH of the resulting slurry. The pH can be modified by, for example, addition of nitric acid. The specific pH of any given slurry can vary depending on the desired solubility and particular components in the slurry. In one aspect, the pH of the resulting slurry is adjusted to a value from about 3.5 to about 4.5. While not wishing to be bound by theory, peptization and/or dispersion of any one or more components in the slurry can help disperse and stabilize the insoluble particulate material in the slurry.

The viscosity of the resulting slurry can also be adjusted, if desired, to provide a slurry capable of at least partially coating a particular substrate. In various aspects, the viscosity of the resulting slurry ranges is less than about 2,000 cP, for example, about 1,950, 1,900, 1,850, 1,800, 1,750, 1,700, 1,600, 1,500, 1,400, 1,200, 1,000, 900, 800, 700, 600, 500, 400, 300, 200, or 100 cP; preferably less than about 500 cP, for example about 490, 480, 470, 460, 450, 440, 430, 420, 410, 400, 380, 360, 340, 320, 300, 275, 250, 225, 200, 175, 150, 125, or 100 cP. In other aspects, the viscosity of the resulting slurry can be equal to or greater than about 2,000 cP or less than about 100 cP and the present invention is not intended to be limited to any particular viscosity. The viscosity of the resulting slurry can be adjusted using any suitable means, such as, for example, addition or water and/or an organic dispersant.

The solids content of the resulting slurry can vary depending on the particular components and concentrations thereof in the slurry. In various aspects, the solids content of the slurry is greater than about 25 wt. %, for example, about 26, 30, 35, 40, 45, or 50 wt. %. In one aspect, the slurry has a high solids content, for example, greater than about 40 wt. % and a low viscosity, for example, less than about 500 cP.

The components of any particular slurry can be contacted and/or mixed in any order suitable for a desired application and the present invention is not limited to any particular order of contacting and/or mixing.

After preparation of the washcoat slurry, a substrate, such as for example, a honeycomb monolith, or a portion thereof can be coated with the washcoat slurry. The particular method for coating and/or applying the washcoat slurry to a substrate can vary, depending on the intended application of the coated article. In various aspects, the washcoat can be applied to the substrate or a portion thereof by, for example, spraying, pouring, brushing, or a combination thereof. In other various aspects, the washcoat can be applied by dipping at least a portion of the substrate into the washcoat slurry. The particular method and/or time of contacting the washcoat slurry and the substrate can vary depending on the properties (e.g., viscosity, solubility, solids content) of the washcoat slurry and on the desired thickness of the washcoat layer to be deposited on the substrate. In one aspect, the washcoat slurry of the present invention is capable of forming a coating having a thickness of up to 3, 4, or 5 mm, or greater if desired. In another aspect, the washcoat slurry of the present invention is capable of forming a coating having a thickness less than about 150 μm, for example, about 150, 125, 100, 75, 50, 25, or 10 μm. In other aspects, the washcoat slurry of the present invention is capable of forming a coating having a thickness of less than about 10 μm or greater than about 5 mm, and the present invention is not intended to be limited to any particular coating thickness.

In one aspect, a substrate can have a porous surface, and upon application of a washcoat coating to the porous surface, at least a portion of the coating can penetrate into the porous surface. In a specific aspect, at least a portion of a washcoat can penetrate at least a portion of the pores of a substrate. In another aspect, a washcoat can be applied to the porous surface of a substrate such that all or substantially all of the washcoat slurry penetrates into the porous surface, wherein no continuous coating is formed on the substrate surface.

If a substrate has voids, channels, and/or other openings, excess washcoat slurry, if present, can optionally be removed after application using any suitable technique, such as, for example, blowing with compressed air.

Once a substrate, such as a monolith, has been coated, the substrate can be dried, allowed to dry, and/or calcined. The parameters of a particular drying and/or calcining step can vary and one of skill in the art could readily select appropriate drying and/or calcining steps for a particular substrate and washcoat slurry.

After drying and/or calcining, a washcoat coated substrate can optionally be contacted with a catalyst, and/or a solution, suspension, or slurry thereof. The catalyst can be any catalyst suitable for use in the intended application. In an exemplary aspect, an iron oxide coated monolith substrate can be dipped into an aqueous solution of either a cationic or anionic transition metal salt of the desired concentration to adsorb a determined amount of catalyst species.

Depending on the particular catalyst solution employed, if this step is performed, the substrate can subsequently be contacted with an activating agent, such as, for example, a reducing agent.

Although several aspects of the present invention have been described in the detailed description, it should be understood that the invention is not limited to the aspects disclosed, but is capable of numerous rearrangements, modifications and substitutions without departing from the spirit of the invention as set forth and defined by the following claims.

### EXAMPLES

To further illustrate the principles of the present invention, the following examples are put forth so as to provide those of ordinary skill in the art with a complete disclosure and description of how the compositions, articles, and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1

### Washcoat Preparation and Application (Prophetic)

In a first example, a washcoat can be prepared by dissolving a quantity of iron nitrate in a polar organic solvent having a low viscosity, such as, for example, ethylene glycol monoethyl ether or ethylene glycol monomethyl ether, and comprising an iron oxide insoluble particulate material, so as to produce a composition comprising from less than about 0.25 M to greater than about 1.5 M iron ion.

A monolith substrate can then be dipped into the resulting composition for a period of time, for example, up to about one minute, and subsequently removed. Any channels and/or other openings in the monolith substrate can be cleared, after dipping, by, for example, blowing with compressed air. The monolith substrate can then be dried and the procedure repeated as needed to increase the loading of iron oxide on the monolith surface.

### Example 2

### Washcoat Preparation and Application (Prophetic)

In a second example, iron nitrate and/or iron chloride can be dissolved in a polar solvent, such as ethylene glycol monoethyl ether to yield a concentration of iron nitrate from less than about 0.25 M to greater than about 1.5 M. Iron oxide, of a predetermined phase and stoichiometry, can then be added to the solution to comprise from about 20 wt. % to about 90 wt. %., depending on the required viscosity of the slurry for washcoating in a particular application. The slurry can then be ball milled for several hours to homogenize and de-agglomerate particles. The viscosity of the slurry can then be further adjusted with an organic dispersant and/or water, if necessary, to less than about 500 cP. The resulting slurry can have a solids content of from about 25 wt. % to about 50 wt. %.

### Example 3

### Washcoat Preparation and Application (Prophetic)

In a third example, an aqueous mixture of from about 50 wt. % to about 90 wt. % iron oxide and from about 10 wt. % to about 50 wt. % boehmite can be prepared. The pH of the resulting mixture can then be adjusted to from about 3.5 to about 4.5 with nitric acid. The pH adjusted mixture can subsequently be ball-milled for several hours to homogenize the mixture. If necessary, water and/or a dispersant can be added to adjust the viscosity of the mixture prior to, during, or subsequent to the ball-milling step to less than about 500 cP.

### Example 4

### Washcoat Preparation and Application (Prophetic)

In a fourth example, iron nitrate can be dissolved in a strong polar solvent, such as ethylene glycol monoethyl ether, to a concentration greater than about 1.5 M. The pH of the resulting solution can be raised to a value greater than about 7 with ammonium hydroxide so as to cause precipitation of iron hydroxide. A monolith can then be immersed in the suspension, dried and calcined. The iron nitrate solution can then be mixed with iron oxide and the pH again adjusted, if necessary, to a value greater than about 7 with the addition of ammonium hydroxide so as to cause precipitation. A monolith can then be coated with the resulting mixture.

### Example 5

### Modified and Catalyzed Washcoats (Prophetic)

In a fifth example, a suspension of iron oxide can be prepared in an aqueous solution of a cationic or anionic transition metal salt, such that after precipitation, drying, and calcination, the catalyst species content can be greater than about 0.01 wt. % of the composition. With constant stirring, the pH can be raised with K₂CO₃ and/or NH₄OH. Alternatively, urea can be added and the temperature raised to decompose the urea, raising the pH. The resulting composition can be washed, dried, and optionally calcined. A suspension of the catalyzed washcoat can be prepared in a solution of iron nitrate in ethylene glycol monoethyl ether. A substrate can then be dipped into the suspension and coated with the catalyzed washcoat. This is an example where the insoluble particulate of the washcoat slurry has been catalyzed. The insoluble particulate can comprise any combination or composition of inorganic oxides or other species that may catalyzed.

Various modifications and variations can be made to the compositions, articles, and methods described herein. Other aspects of the compositions, articles, and methods described herein will be apparent from consideration of the specification and practice of the compositions, articles, and methods disclosed herein. It is intended that the specification and examples be considered as exemplary.

What is claimed is:

1. A washcoat composition comprising:
(a) a soluble washcoat salt species;
(b) a polar organic solvent; and
(c) an insoluble particulate material.

2. The washcoat composition of claim 1, wherein the insoluble particulate material is an oxide.

3. The washcoat composition of claim 1, wherein the insoluble particulate material is an oxide, and where the insoluble particulate material and the soluble washcoat salt species comprise a same cation.

4. The washcoat composition of claim 1, wherein the insoluble particulate material comprises an iron oxide.

5. The washcoat composition of claim 1, wherein the soluble washcoat salt species comprises an iron compound.

6. The washcoat composition of claim 1, wherein the soluble washcoat salt species comprises at least one of a nitrate, a halide, a carboxylate, or a combination thereof.

7. The washcoat composition of claim 1, wherein the soluble washcoat salt species comprises at least one of iron nitrate, iron chloride, copper chloride, zinc nitrate, or a combination thereof.

8. The washcoat composition of claim 1, wherein the polar organic solvent comprises ethylene glycol monoethyl ether, ethylene glycol monomethyl ether, or a combination thereof.

9. A substrate at least partially coated with the washcoat composition of claim 1.

10. The substrate of claim 9, wherein the substrate is a honeycomb monolith.

11. A method for making a washcoat composition, the method comprising contacting a soluble washcoat salt species, a polar organic solvent, and an insoluble particulate material.

12. The method of claim 11, wherein the soluble washcoat salt species and the insoluble particulate material comprise a same cation.

13. The method of claim 11, wherein the soluble washcoat salt species comprises an iron compound.

14. A method for coating a substrate with a washcoat, the method comprising contacting at least a portion of a substrate with the washcoat composition of claim 1.

15. The method of claim 14, further comprising after contacting at least a portion of a substrate with the washcoat composition of claim 1, at least one of drying and/or calcining the substrate.

16. The method of claim 14, further comprising, after contacting at least a portion of a substrate with the washcoat composition of claim 1, contacting the at least a portion of the substrate with a catalyst.

17. The method of claim 14, wherein the substrate comprises a honeycomb monolith.

18. An article produced by the method of claim 14.
